(19) United States
(12) Patent Application Publication
(10) Pub. No.: US 2026/0151875 A1
(43) Pub. Date: Jun. 4, 2026

(54) Drill Clamp Tool

(71) Applicant: The Boeing Company, Arlington, VA (US)

(72) Inventors: Michael Christopher Hunt, Ravenel, SC (US); Travis MacGyver Laffey, Goose Creek, SC (US)

(21) Appl. No.: 19/365,603

(22) Filed: Oct. 22, 2025

Related U.S. Application Data
(60) Provisional application No. 63/726,840, filed on Dec. 2, 2024.

(51) Int. Cl. B25B 5/06; B23B 47/28

(52) U.S. Cl. CPC B25B 5/067; B23B 47/287

(57) ABSTRACT

A drill clamp tool that includes a body sized and configured to extend along a first side and a second side of a workpiece. The tool includes a sleeve at a first section of the body for positioning at the first side. The tool also includes a clamping member on a second section of the body for positioning at the second side. An opening extends through the sleeve and a corresponding opening extends into the face of the clamping member. When the tool is connected to the workpiece, the openings are colinearly aligned on opposing sides of the workpiece. During the drilling process, a user inserts a drill bit into the opening in the sleeve and then drills a hole in the workpiece. At least a tip of the drill bit moves through the workpiece and is inserted into the opening in the contact pad.

### RELATED APPLICATIONS

The present application claims the benefit of U.S. Provisional Application No. 63/726840, filed Dec. 2, 2024, which is hereby incorporated by reference in its entirety.

### TECHNOLOGICAL FIELD

The present disclosure relates generally to the field of drill guides and, more specifically, to drill guides configured to be clamped onto a workpiece.

### BACKGROUND

A variety of tools can be used to drill a hole in workpiece. One tool is a drill guide that generally includes a body with sets of holes that are spaced apart along the body. During use, the drill guide is positioned at the workpiece and the applicable hole set is aligned at the desired location on the workpiece. The drill guide is held in position by the user and/or by clamps or mechanical fasteners. Once the drill guide is positioned and secured, the user inserts a drill bit into the hole in the drill guide and then drills the hole in the workpiece.

Although drill guides can provide for forming precise holes in a workpiece, existing drill guides have a variety of drawbacks. It is often necessary for the user to hold the drill guide during use. This may require the user to position their hands and fingers in proximity to the drill and drill bit during the drilling process. To ensure the safety of the user and prevent accidents, it is desirable for the user to have their hands and fingers distanced away from the drill/drill bit during the drilling process.

Another issue occurs when clamps are used to secure the drill guide to the workpiece. The clamps often interfere with the drilling process. When attempting to drill a hole in a relatively small or restricted space, the clamps may be too large for the space and cannot be used. In some instances, the clamps extend over the drill guide and prevent the drill bit from being inserted into the holes in the drill guide and thus it is not possible to drill the hole in the workpiece.

### SUMMARY

One aspect is directed to a drill clamp tool to engage with a workpiece. The drill clamp tool comprises a body with an elongated shape and comprising a first section in proximity to a first end and a second section in proximity to a second end and comprising a threaded opening. A sleeve is positioned at the first section and comprises a sleeve opening that extends through the sleeve. A clamping member comprises a threaded shaft that extends through the threaded opening in the second section, and a contact pad connected to the threaded shaft with the contact pad comprising a contact pad opening that extends into the contact pad. The threaded shaft is rotatable within the second section to selectively adjust a distance between the sleeve and the contact pad to apply a clamping force to the workpiece. The sleeve opening and the contact pad opening are aligned along a drilling axis that is a straight line.

In another aspect, the sleeve is integrally formed with the body as a unitary, one-piece member.

In another aspect, the body is substantially c-shape with a central section sized to extend along an edge of the workpiece, a first arm that includes the first section and that extends from a first end of the central section to is configured to be positioned along a first side of the workpiece and a second arm that includes the second section and that extends from a second end of the central section and is configured to be positioned along a second side of the workpiece.

In another aspect, relief ports are positioned at an inner side of the sleeve and in communication with the sleeve opening with the relief ports configured to accommodate debris during a drilling process.

In another aspect, a bushing is mounted in the sleeve opening with the bushing comprising a central opening that is aligned along the drilling axis.

In another aspect, the contact pad opening is centered on the contact pad.

In another aspect, the contact pad opening extends through the entirety of the contact pad and the threaded shaft.

In another aspect, the contact pad opening extends a limited distance into the contact pad and wherein the contact pad opening comprises a bottom edge.

In another aspect, the contact pad is pivotally mounted to the threaded shaft.

One aspect is directed to a drill clamp tool to engage with a workpiece. The drill clamp tool comprises an elongated body comprising an inner side and an outer side, a first end, a second end, an intermediate section that extends between the first end and the second end with the intermediate section comprising a bent shape with the first end and the second end spaced apart by a gap, and a sleeve opening that extends through the body at the first end. A clamping member is mounted to the body at the second end with the clamping member comprising a shaft that extends through the body at the second end. A contact pad is mounted to the shaft and positioned in the gap of the body between the first end and the second end with the contact pad comprising a contact face and a central opening. The shaft is movable relative to the body to adjust a distance between the contact face of the contact pad and the inner side of the first end.

In another aspect, the sleeve opening and the central opening are aligned along a straight drilling axis.

In another aspect, the sleeve opening and the central opening are centered along a straight drilling axis.

In another aspect, ports are positioned at the inner side of the body at the sleeve opening with the ports in communication with the sleeve opening.

In another aspect, a bushing is positioned in the sleeve opening with the bushing comprising a cylindrical shape with a central opening.

In another aspect, the contact pad is pivotally mounted to an end of the threaded shaft.

In another aspect, the second end of the body comprises a threaded opening that receives the threaded shaft of the clamping member.

One aspect is directed to a method of drilling a hole in a workpiece. The method comprises: positioning a sleeve of a drill clamp tool on a first side of the workpiece; positioning a clamping member of the drill clamp tool on a second side of the workpiece; aligning an opening in the sleeve with a point on the first side of the workpiece; tightening the clamping member and securing the drill clamp tool to the workpiece with the sleeve aligned with the point and contacting against the first side and the clamping member contacting against the second side of the workpiece; inserting a drill bit into the opening in the sleeve and drilling the hole in the workpiece at the point; and moving the drill bit through the workpiece and inserting at least a tip of the drill bit into an opening in the clamping member.

In another aspect, the method also comprises forcing drilling debris through the opening in the clamping member and out through an open end of the opening that is positioned away from the workpiece.

In another aspect, the method also comprises positioning a body of the drill clamp tool around a lateral edge of the workpiece and positioning the sleeve on the first side of the workpiece and the clamping member on the second side of the workpiece.

In another aspect, the method also comprises forcing drilling debris out of the opening in the sleeve through ports that are positioned at a face of the sleeve.

The features, functions and advantages that have been discussed can be achieved independently in various examples or may be combined in yet other examples, further details of which can be seen with reference to the following description and the drawings.

### BRIEF DESCRIPTION OF THE DRAWINGS

FIG. 1 is a schematic diagram of a drill clamp tool attached to a workpiece and act as a guide for a drill.

FIG. 2 is an isometric view of a drill clamp tool.

FIG. 3 is an isometric view of a sleeve that includes ports.

FIG. 4 is an isometric view of a drill clamp tool with a contact member aligned at a first angular position.

FIG. 5 is an isometric view of a drill clamp tool that illustrates an opening that extends through a shaft of a clamping member.

FIG. 6 is an isometric view of the drill clamp tool of FIG. 4 with the contact member aligned at a second angular position.

FIG. 7 is an isometric view of a drill clamp tool attached to a workpiece and with a drill inserted into the tool.

FIG. 8 is a flowchart diagram of a method of drilling a hole in a workpiece.

### DETAILED DESCRIPTION

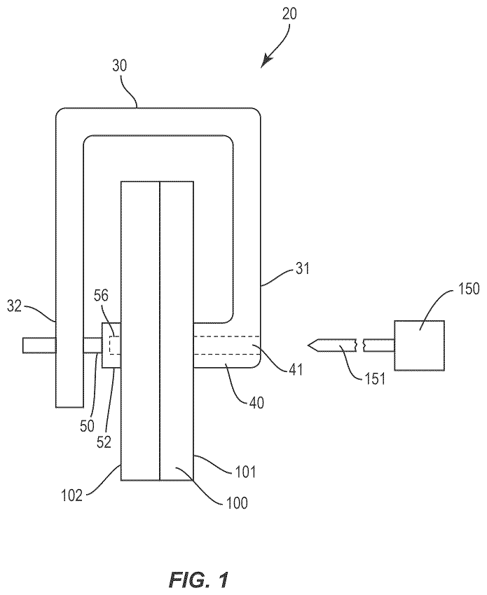

FIG. 1 schematically illustrates a drill clamp tool 20 (hereinafter tool 20) attached to a workpiece 100. The tool 20 generally includes a body 30 sized and configured to extend along a first side 101 and a second side 102 of the workpiece 100. The tool 20 includes a sleeve 40 at a first section 31 of the body 30 for positioning at the first side 101. The tool 20 also includes a clamping member 50 on a second section 32 of the body 30 for positioning at the second side 102. An opening 41 extends through the sleeve 40. A corresponding opening 56 extends into the face of the clamping member 50. When the tool 20 is connected to the workpiece, the openings 41, 56 are aligned in a straight line on opposing sides of the workpiece 100. During the drilling process, a user inserts a drill bit 151 of the drill 150 into the opening 41 in the sleeve 40 and then drills a hole in the workpiece 100. At least a tip of the drill bit 151 moves through the workpiece 100 and is inserted into the opening 56 in the contact pad 52.

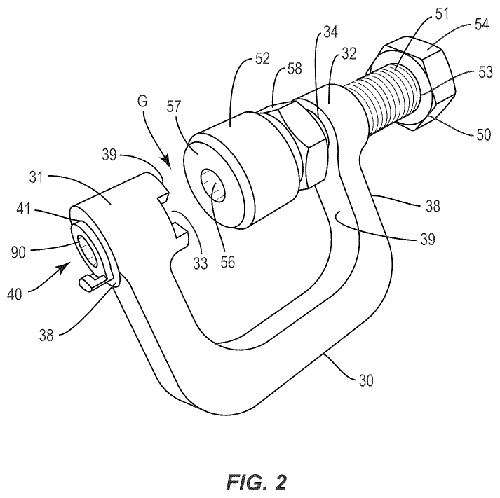

FIG. 2 illustrates an example of a tool 20. The tool 20 includes a body 30, sleeve 40, and clamping member 50. The body 30 is sized and shaped to locate the sleeve 40 and the clamping member 50 on opposing sides of the workpiece 100 (not illustrated in FIG. 2). The body 30 has an elongated shape with a first section 31 in proximity to a first end and a second section 32 in proximity to the second end. The body 30 has a bent shape that aligns and spaces apart the first section 31 and the second section 32. In the example of FIG. 2, the body 30 has a substantially C-shape that locates the first and second sections on opposing sides of a gap G. Other examples include a variety of other shapes and/or sizes that enable this positioning. The body 30 also includes an inner side 39 that faces into the interior space and an opposing outer side 38 that faces in the opposite direction.

In some examples as illustrated in FIG. 2, the body 30 has a unitary, one-piece construction that extends from the first section 31 to the second section 32. Other examples include the body 30 formed by multiple different sections. The body 30 can be constructed from a variety of different materials, including but not limited to various metals.

The sleeve 40 is positioned at the first section 31 of the body 30. In some examples, the sleeve 40 is positioned at the first end of the body 30, with other examples positioning the sleeve 40 inward from the first end. In some examples as illustrated in FIG. 2, the sleeve 40 and body 30 include a unitary, one-piece construction. In other examples, the sleeve 40 is a separate piece that is connected to the body 30.

The sleeve 40 includes an opening 41 that extends through the first section 31 of the body 30 and is exposed on both the outer side 38 and the inner side 39. The opening 41 can include a variety of shapes and sizes. In some examples, the opening 41 forms a drill guide to locate the drill bit 151 during the drilling process. Additionally or alternatively, a bushing 90 is positioned in the opening 41. The bushing 90 is sized to correspond to the drill bit 151 and locates the drill bit 151 during the drilling process. The bushing 90 is sized to extend within the opening 41 and includes an inner opening sized to receive the drill bit 151. In some examples, the bushing 90 has a substantially cylindrical shape to fit and extend within the opening 41. The opening 41 can include various shapes and sizes to receive a variety of different bushings 90.

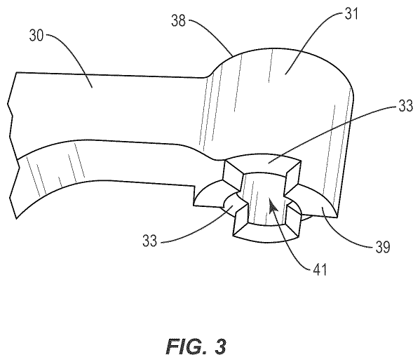

As illustrated in FIGS. 2 and 3, one or more ports 33 are located at the opening 41 along the inner sides 39. The ports 33 are in communication with the opening 41 and allow for debris formed during the drilling process to escape.

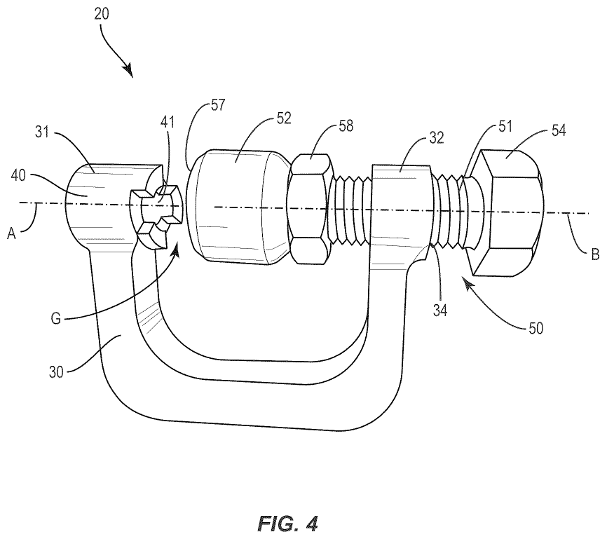

As illustrated in FIG. 4, opening 41 has a straight center line that forms a sleeve axis A. In some examples, the sleeve axis A is perpendicular to the inner side of the sleeve 40. This perpendicular orientation ensures that holes formed in the workpiece 100 during the drilling process are perpendicular to the first side 101 of the workpiece 100.

The second section 32 of the body 30 is configured to receive the clamping member 50. As illustrated in FIGS. 2 and 4, the second section 32 includes an opening 34 that is exposed on the outer side 38 and the inner side 39. In some examples, the opening 34 is threaded along the length to engage with the threaded clamping member 50. The second section 32 can be positioned at the second end of the body as illustrated in FIGS. 2 and 4 or can be spaced inward away from the second end.

The clamping member 50 is connected to the body 30 and configured to apply a clamping force to attach the tool 20 to the workpiece 100. The clamping member 50 includes a shaft 51 and a contact pad 52. The clamping member 50 is movable relative to the body 30 to adjust a size of a gap G between the contact pad 52 and the sleeve 40.

The shaft 51 is positioned within and engages with the body 30 at the opening 34. The threads 53 can extend along the entirety or a limited section of the length and engage with corresponding threads within the opening 34. The threaded connection between the shaft 51 and body 30 enables selectively positioning of the shaft 51 relative to the body 30. The shaft 51 includes an elongated shape with the contact pad 52 mounted to an inner end. An outer end of the shaft 51 is configured to be positioned outward from the body 30. In some examples, the outer end includes a head 54 that extends radially outward from the beyond the shaft 51. The head 54 includes a larger diameter than the outer diameter of the opening 34 to prevent the outer end of the shaft 51 from moving into the opening 34. The head 54 also facilitates gripping and rotating by the user.

The contact pad 52 is mounted to the inner end of the shaft 51. The contact pad 52 includes a contact face 57 that contacts against the workpiece 100 during attachment of the tool 20. In some examples, the contact pad 52 includes a threaded opening opposite from the contact face 57. The threaded opening enables attachment to the inner end of the threaded shaft 51. In other examples, the contact pad 52 is connected to a nut 58 that is threaded onto the shaft 51. The nut 58 further includes an extension that extends into an opening in contact pad 52 to enable the contact pad 52 to pivot relative to the shaft 51.

As illustrated in FIG. 2, an opening 56 extends into the contact face 57. The opening 56 is aligned with the opening 41 of the sleeve 40. The opening 56 enables the drill bit 151 to move completely through the workpiece 100 during the drilling process and receives the tip of the drill bit 151 as it exits the workpiece 100. To enable receiving the drill bit 151, the opening 56 is aligned with the opening 55 in the shaft 51. The opening 56 also receives debris that is formed during the drilling process.

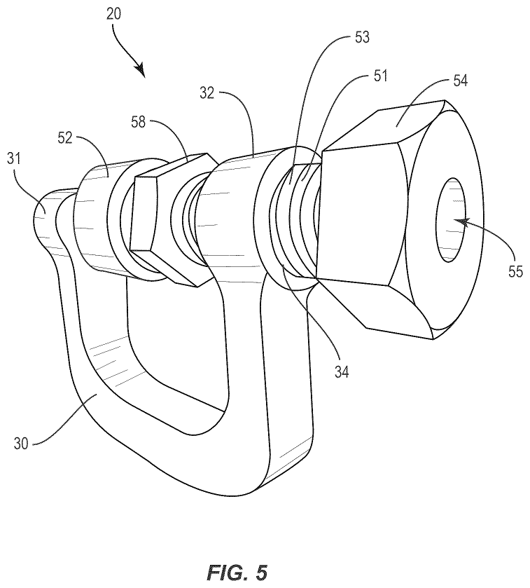

The depth of the opening 56 into the contact pad 52 can vary. In some examples, the opening 56 extends a limited distance into the contact pad 52. In these examples, the opening 56 includes a bottom that is positioned within the interior of the contact pad 52. In other examples, the opening 56 extends completely through the contact pad 52. In some examples as best illustrated in FIG. 5, an opening 55 extends through an interior of the shaft 51. The openings 55, 56 are colinear and align along a clamping member axis B (see FIG. 4). In some examples, the opening 55 extends a limited distance into the shaft 51 from the inner end. In other examples as illustrated in FIG. 5, the opening 55 extends completely through the length of the shaft 51. This configuration enables drilling debris to move through the opening 56 in the contact pad 52 and the opening 55 in the shaft 51 and be expelled from the exposed end of the opening 55 at the head 54.

In some examples, the contact pad 52 is pivotally attached to the shaft 51. The extent of pivoting movement can vary. In some examples, the contact pad 52 is able to pivot up to 10° in various angles around the clamping member axis B.

FIG. 4 illustrates the tool 20 with the clamping member 50 in a first configuration with the contact pad 52 aligned with the shaft 51. The center axis of the contact pad 52 is colinear with the center axis of the shaft 51. In this example, the entire clamping member axis B that includes the center axes of both the contact pad 52 and the shaft 51 are colinear with the sleeve axis A. In some examples, this configuration occurs when the first side 101 and the second side 102 of the workpiece 100 are parallel.

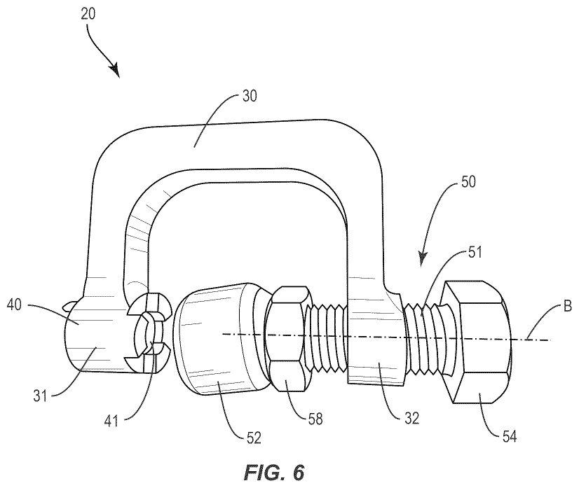

FIG. 6 illustrates the tool in a second configuration. The contact pad 52 is misaligned with the center axis B of the shaft 51. This orientation enables the contact pad 52 to accommodate a workpiece 100 with the first side 101 oriented at an uneven (i.e., non-parallel) angle relative to the second side 102.

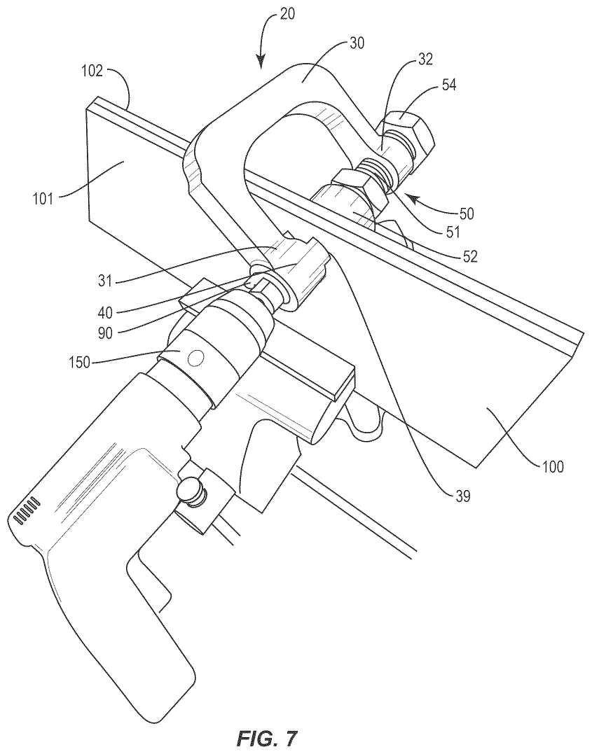

FIG. 7 illustrates the tool 20 attached to a workpiece 100. The body 30 straddles the workpiece 100 with the sleeve 40 positioned on the first side 101 and the clamping member 50 positioned on the second side 102. The tool 20 is aligned by locating the opening 41 on the sleeve 40 at a desired point on the workpiece 100. Once positioned, the clamping member 50 is tightened to secure the tool 20 at that location. The tightening includes the user rotating and moving the shaft 51 along the threads in the opening 34 in the second section 32 of the body 30. In some examples, this includes the user grasping and rotating the head 54 of the shaft 51. During the process, the inner side 39 of the sleeve 40 contacts against the first side 101 and the contact face 57 of the contact pad 52 contacts against the second side 102. The pivoting attachment of the contact pad 52 relative to the shaft 51 enables the contact face 57 to fully contact against the second side 102.

After the tool 20 is attached to the workpiece 100, the user aligns the drill 150 and drill bit 151 (not illustrated in FIG. 7). In some examples, the bushing 90 corresponding to the drill bit 151 is inserted into the opening 41 prior to attachment to the workpiece 100. In other examples, the bushing 90 is inserted after the tool 20 is attached to the workpiece 100. In still other examples, no bushing 90 is used as the opening 41 acts as the drill guide.

The drill bit 151 is inserted into the bushing 90 which acts as a guide to align with the first side 101. In some examples, this ensures that the drill bit 151 is aligned perpendicular to the first side 101 during the drilling process.

During the drilling process, the drill bit 151 moves through the workpiece 100 to form the hole. As the drill bit 151 moves through the workpiece 100, the tip moves into the opening 56 in the contact pad 52. The amount of the drill bit 151 that extends into the opening 56 depends upon various factors such as the length of the drill bit 151, the thickness of the workpiece, and the depth of the opening 56. Once the drilling is completed, the drill 150 and drill bit 151 are moved in an opposing direction and removed from the workpiece 100 and the sleeve 40. Once removed, the tool 20 can be removed from the workpiece 100 by loosening the clamping member 50.

During the drilling process, drilling debris is able to move through the exit ports 33. Drilling debris is also able to move into the opening 56. In examples with the opening extending completely through the clamping member 50, the drilling debris can be expelled through the outer end of the shaft 51.

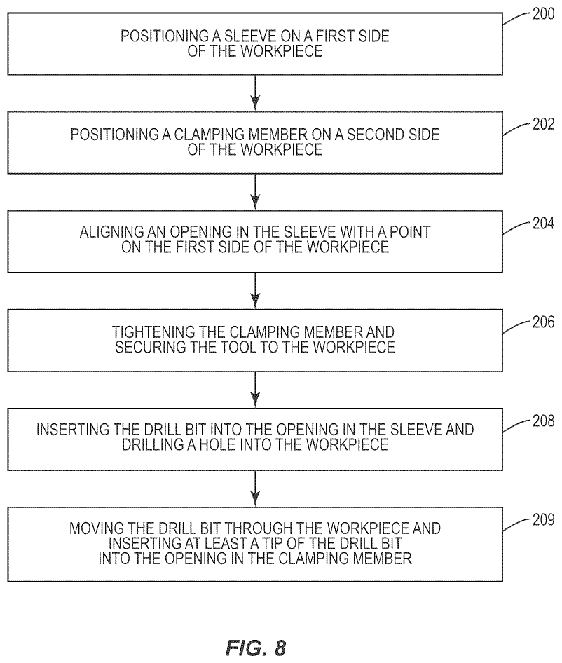

FIG. 8 illustrates a method of drilling a hole in a workpiece 100. The method includes positioning a sleeve 40 on a first side 101 of the workpiece 100 (block 200) and a clamping member 50 on a second side 102 of the workpiece 100 (block 202). The opening 41 in the sleeve 40 is aligned with a point on the first side 101 of the workpiece 100 where the hole is to be drilled (block 204). Once aligned, the clamping member 50 is tightened to secure the tool 20 to the workpiece 100 (block 206). When secured to the workpiece 100, the sleeve 40 is aligned with the point and contacts against the first side 101 and the clamping member 50 contacts against the second side 102. After the tool 20 is secured, the drill bit 151 is inserted into the opening 41 in the sleeve 40 and a hole is drilled into the workpiece 100 (block 208). The drilling process includes moving the drill bit 151 through the workpiece 100 and inserting at least a tip of the drill bit 151 into the opening 56 in the clamping member 50 (block 209).

By the term “substantially” with reference to amounts or measurement values, it is meant that the recited characteristic, parameter, or value need not be achieved exactly. Rather, deviations or variations, including, for example, tolerances, measurement error, measurement accuracy limitations, and other factors known to those skilled in the art, may occur in amounts that do not preclude the effect that the characteristic was intended to provide.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A drill clamp tool to engage with a workpiece, the drill clamp tool comprising:
a body with an elongated shape and comprising a first section in proximity to a first end and a second section in proximity to a second end and comprising a threaded opening;
a sleeve positioned at the first section and comprising a sleeve opening that extends through the sleeve;
a clamping member comprising:
a threaded shaft that extends through the threaded opening in the second section;
a contact pad connected to the threaded shaft, the contact pad comprising a contact pad opening that extends into the contact pad;
wherein the threaded shaft is rotatable within the second section to selectively adjust a distance between the sleeve and the contact pad to apply a clamping force to the workpiece; and
wherein the sleeve opening and the contact pad opening are aligned along a drilling axis that is a straight line.

2. The drill clamp tool of claim 1, wherein the sleeve is integrally formed with the body as a unitary, one-piece member.

3. The drill clamp tool of claim 1, wherein the body is substantially c-shape with a central section sized to extend along an edge of the workpiece, a first arm that includes the first section and that extends from a first end of the central section to is configured to be positioned along a first side of the workpiece and a second arm that includes the second section and that extends from a second end of the central section and is configured to be positioned along a second side of the workpiece.

4. The drill clamp tool of claim 1, further comprising relief ports positioned at an inner side of the sleeve and in communication with the sleeve opening, the relief ports configured to accommodate debris during a drilling process.

5. The drill clamp tool of claim 1, further comprising a bushing mounted in the sleeve opening, the bushing comprising a central opening that is aligned along the drilling axis.

6. The drill clamp tool of claim 1, wherein the contact pad opening is centered on the contact pad.

7. The drill clamp tool of claim 1, wherein the contact pad opening extends through the entirety of the contact pad and the threaded shaft.

8. The drill clamp tool of claim 1, wherein the contact pad opening extends a limited distance into the contact pad and wherein the contact pad opening comprises a bottom edge.

9. The drill clamp tool of claim 1, wherein the contact pad is pivotally mounted to the threaded shaft.

10. A drill clamp tool to engage with a workpiece, the drill clamp tool comprising:
an elongated body comprising:
an inner side and an outer side;
a first end;
a second end;
an intermediate section that extends between the first end and the second end, the intermediate section comprising a bent shape with the first end and the second end spaced apart by a gap;
a sleeve opening that extends through the body at the first end;
a clamping member mounted to the body at the second end, the clamping member comprising:
a shaft that extends through the body at the second end;
a contact pad mounted to the shaft and positioned in the gap of the body between the first end and the second end, the contact pad comprising a contact face and a central opening;
wherein shaft is movable relative to the body to adjust a distance between the contact face of the contact pad and the inner side of the first end.

11. The drill clamp of claim 10, wherein the sleeve opening and the central opening of the contact pad are aligned along a straight drilling axis.

12. The drill clamp of claim 10, wherein the sleeve opening and the central opening of the contact pad are centered along a straight drilling axis.

13. The drill clamp of claim 10, further comprising ports positioned at the inner side of the body at the sleeve opening, the ports are in communication with the sleeve opening.

14. The drill clamp of claim 10, further comprising a bushing that is positioned in the sleeve opening, the bushing comprising a cylindrical shape with a central opening.

15. The drill clamp of claim 10, wherein the contact pad is pivotally mounted to an end of the threaded shaft.

16. The drill clamp of claim 10, wherein the second end of the body comprises a threaded opening that receives the threaded shaft of the clamping member.

17. A method of drilling a hole in a workpiece, the method comprising:
positioning a sleeve of a drill clamp tool on a first side of the workpiece;
positioning a clamping member of the drill clamp tool on a second side of the workpiece;
aligning an opening in the sleeve with a point on the first side of the workpiece;
tightening the clamping member and securing the drill clamp tool to the workpiece with the sleeve aligned with the point on the first side and the clamping member contacting against the second side of the workpiece;
inserting a drill bit into the opening in the sleeve and drilling the hole in the workpiece at the point; and
moving the drill bit through the workpiece and inserting at least a tip of the drill bit into an opening in the clamping member.

18. The method of claim 17, further comprising forcing drilling debris through the opening in the clamping member and out through an open end of the opening that is positioned away from the workpiece.

19. The method of claim 17, further comprising positioning a body of the drill clamp tool around a lateral edge of the workpiece and positioning the sleeve on the first side of the workpiece and the clamping member on the second side of the workpiece.

20. The method of claim 17, further comprising forcing drilling debris out of the opening in the sleeve through ports that are positioned at a face of the sleeve.
